(19) United States
(12) Patent Application Publication
(10) Pub. No.: US 2004/0249739 A1
(43) Pub. Date: Dec. 9, 2004

(54) Systems and methods for patent portfolio managemnt and expense forecasting

(76) Inventor: Laurie A. Axford, San Diego, CA (US)

Correspondence Address: Laurie A. Axford, 732 West Harbor Drive, San Diego, CA, 92101, US

(21) Appl. No.: 10/456,925

(22) Filed: Jun. 5, 2003

(51) Int. Cl. G06F 17/60

(52) U.S. Cl. 705/36

(57) ABSTRACT

The present invention relates to computer systems and methods for managing complex patent portfolios and forecasting patent expenses. In one embodiment, the present invention relates to computer systems and methods for calculating future patent expenses on a real-time ongoing basis, including prosecution costs and maintenance fees, based on user-inputted, calculated and/or preprogrammed parameters specific to a user's patent portfolio.

### TECHNICAL FIELD

The present invention relates to computer systems and methods for managing complex patent portfolios and forecasting patent expenses. In one embodiment, the, present invention relates to computer systems and methods for calculating future patent expenses on a real-time ongoing basis, including prosecution costs and maintenance fees, based on user-inputted, calculated and/or preprogrammed parameters specific to a user's present or prospective patent portfolio.

### BACKGROUND OF THE INVENTION

Patent portfolio management can be a complex process for any technology based company. As the business environment and economy continues to globalize, more and more patents are filed on a worldwide basis. As such, a single “family” of patents (i.e. individual patents filed in different countries/regions based on the same or a similar specification) may be filed in 10, 20 or even more than 50 different countries/regions. Since most technology based companies file multiple patent families to cover different inventions, the size of a company's patent portfolio can increase almost exponentially during development and advancement of the company's technology objectives.

Expense management of a patent portfolio is also a complex undertaking. As a patent estate grows in size and becomes globalized, expense analysis must be adaptable and based on an accurate status of a patent/patent application at any given time, taking into consideration the rules in each country/region that dictate individual patent expenses. The analysis is additionally made difficult because of the need to reevaluate expenses on a real time regular basis because of fluctuating exchange rates in the countries in which the expenses are owed, as well as frequent changes to the rules/laws in the individual jurisdictions in which patents are filed that result in changes to expense parameters.

The value of any given technology based company lies primarily in its intellectual property. However, one of the most difficult tasks of company management is the ability to correlate patent related expenses to specific business objectives. Thus, the ability to track and predict patent expenses quickly and efficiently on a real time basis is necessary in order to enable reallocation of expenses based on changing corporate strategies.

Software and web based systems for docketing and managing patent portfolios and/or projecting patent expenses on a fixed time basis include, inter alia, IPPO from IP Online Ltd. (Santa Barbara, Calif.), Patent Management Systems from Computer Packages, Inc. (Rockville, Md.), Worldsuite from Edital Intellectual Property Network (Chicago, Ill.), and Global IP Estimator from Global IP Net (Kihei, Hi.). Although Global IP Estimator provides the user with information about filing, prosecution and maintenance costs, its data storage and expense prediction capabilities are limited to individual patent “scenarios” based on a chosen time frame (i.e., year one, two, three, etc.) Indeed, none of the aforementioned systems allow for real time (i.e. calendar date-specific) predictions that are also capable of automatic recalcuation based on paradigm changes.

Accordingly, no one system enables the user to simultaneously track portfolio status and expenses on a real time basis without having to input the same information into multiple modules or systems, or having to completely duplicate entries every time an updated expense forecast is needed. Thus, a need exists for a more comprehensive and user-friendly system to manage patent portfolio status and expenses on an ongoing basis.

### SUMMARY OF THE INVENTION

The present invention relates, among other things, to a system for forecasting patent expenses on a given date for a patent portfolio that includes at least one patent family, but may of course also include more than one patent family as most portfolios do. The system includes an input device for inputting patent data corresponding to expense-associated variables for each patent in the portfolio, although the system user inputting the data is not necessarily required to input all the data for each patent in the portfolio, because of the self-populating feature of the invention that is described in detail elsewhere herein.

The data necessarily includes at least one actual or anticipated filing or grant date for at least one patent in each patent family in the portfolio in order to “anchor” the data to an actual calendar date for the purpose of forecasting expenses over a future range of dates. As with all computer systems of this type, the system will also include a storage device for saving the data, which will allow it to be recalled for purposes of making alterations or for reforecasting the data based on updated programming parameters, changes in currency rates, etc. Accordingly, the system also includes a processor for converting the data into monetary values based on algorithms or “rules” for the data that are usually preprogrammed into the system by a system administrator.

The system also includes an output device for printing or displaying output of the monetary values over a specific time frame. As mentioned previously, the system is capable of self-populating the outcome with preprogrammed values when the patent data corresponding to the expense-associated variables is incomplete. In other words, if the system user is unable to enter expense-associated data, such as the number of claims on which many jurisdictions base their filing fees, the system will supply an outcome value based on an industry standard number of claims. The outcome may then include a notation referencing this industry standard number of claims which was used in the place of a system user input value, or it may simply provide the calculated value in the outcome.

In a preferred embodiment, the patent in each patent family used to anchor the date of the outcome is the parent patent, and the date is usually the actual or anticipated filing date of the parent application, most usually the actual filing date. In another embodiment, the patent used to anchor the date of the outcome is a granted patent, in which case the date is usually the grant date of the patent. For example, if the patent family consists only of issued patents and the desired outcome is a forecast of maintenance fees for the family, the grant dates can be entered and the maintenance fees estimated over a specific time frame. Alternatively, if the patents in the patent family are still pending, it is possible to use anticipated grant dates to perform the forecast.

Another aspect of the present invention is a method for forecasting patent expenses on a given date using the aforementioned system. Other aspects of the present invention are described throughout the specification.

### BRIEF DESCRIPTION OF THE DRAWINGS

FIG. 1 depicts sample expenses for national phase filing in the U.S. from the PCT.

FIG. 2 depicts sample fees for PCT Chapter I.

FIG. 3 depicts sample fees for PCT Chapter II.

FIG. 4 depicts a sample system user worksheet.

FIG. 5 depicts sample national phase expenses for a British patent.

FIG. 6 depicts sample European patent expenses.

FIG. 7 depicts sample actions and timing rules.

FIG. 8 depicts sample forecast outputs.

FIG. 9 depicts patent data for a model patent family.

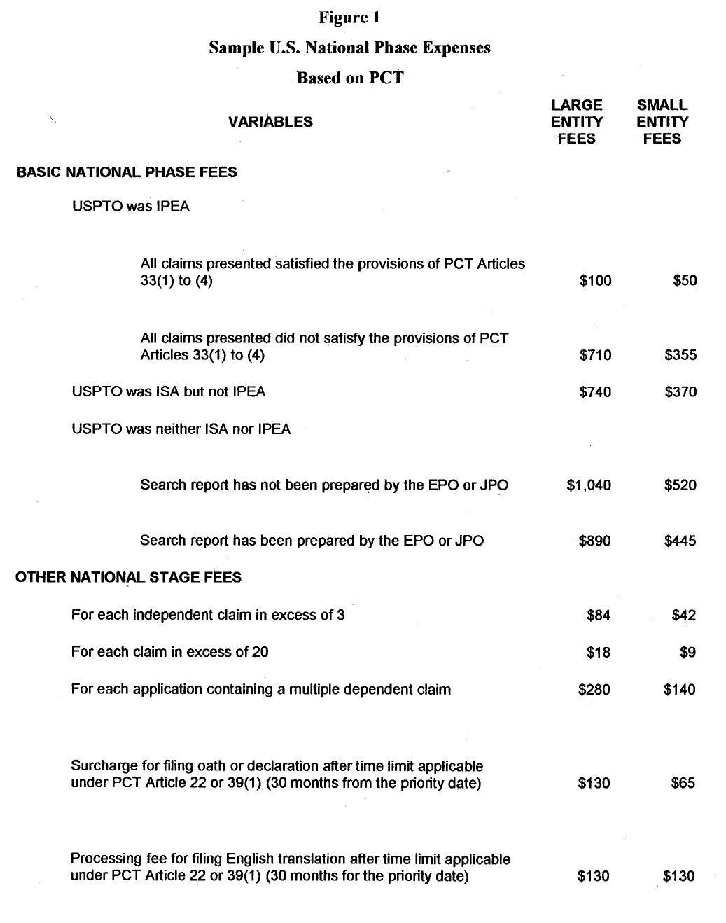

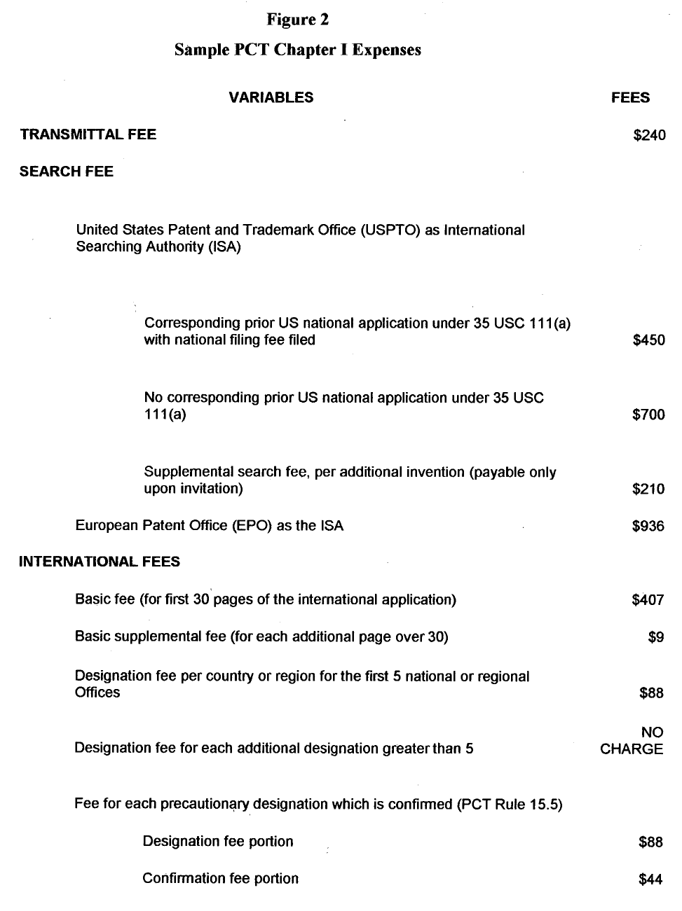

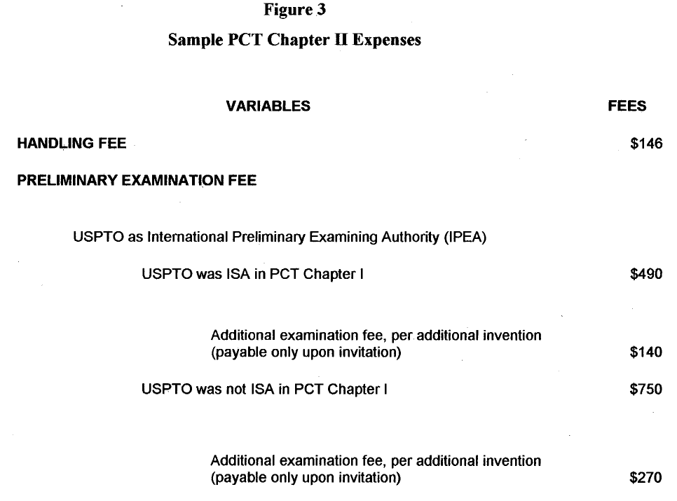

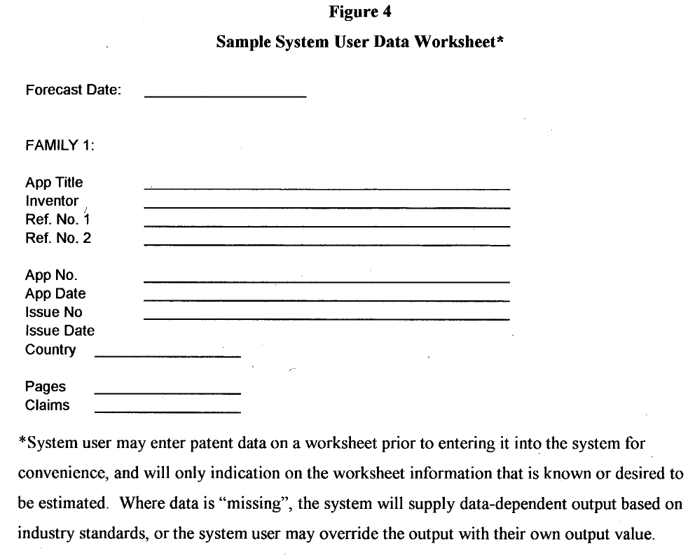

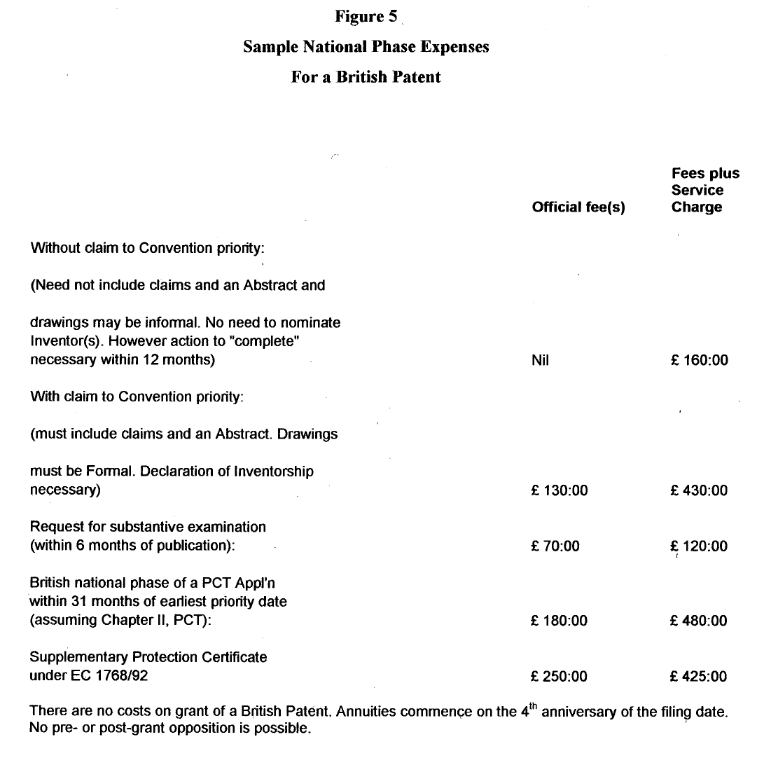

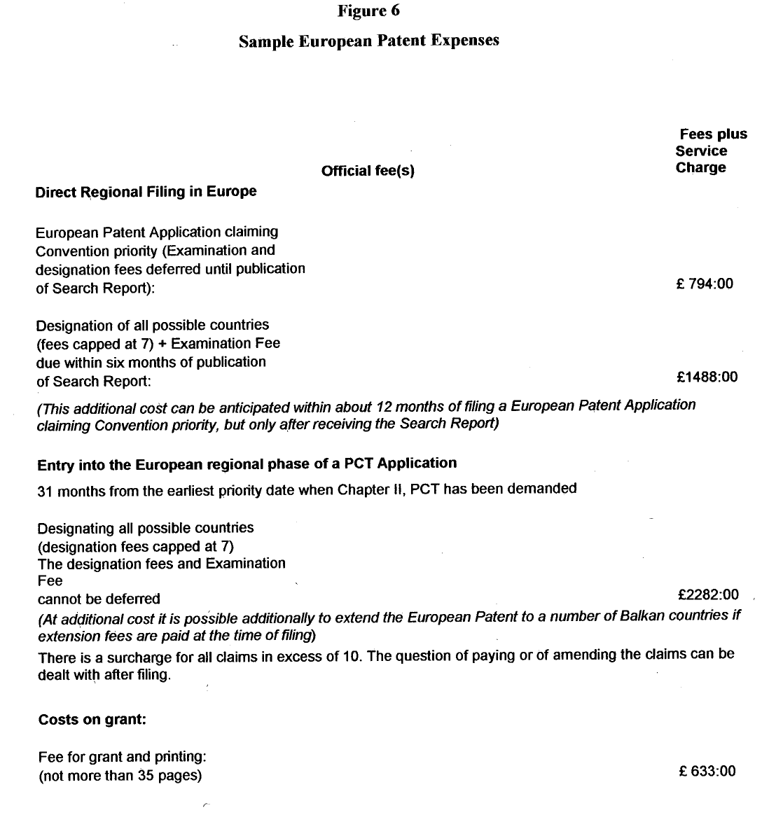

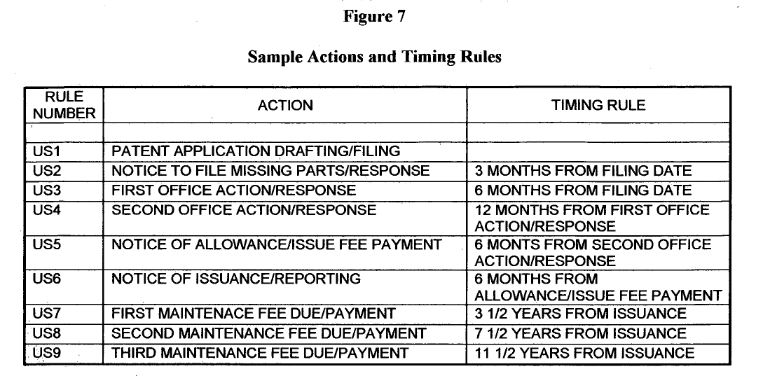

### DESCRIPTION OF THE INVENTION

The present invention relates to computer systems and methods for managing complex patent portfolios and forecasting patent expenses. In one embodiment, the present invention relates to computer systems and methods for calculating future (i.e. forecasting) patent expenses on a real-time, ongoing basis. Such expenses may include, for example, prosecution expenses, government costs, legal fees, maintenance costs, etc. These expenses are calculated on the basis of system user inputted data which is in turn converted by the system into expense-related values, system-programmed default values, and/or user supplied actual or default values which are specific to a particular patent portfolio or forecasting circumstances.

The systems and methods of the present invention are particularly well suited for managing complex patent portfolios for sizeable business entities that must be able to reliably predict expenses well into the future. In addition, the systems and methods of the present invention are useful in evaluating the future expenses of prosecuting and/or maintaining an actual or prospective patent portfolio that may be an attractive acquisition or investment target, in which case understanding future expense parameters is an important aspect of the pre-acquisition/investment due diligence process.

A particularly unique and important feature of the systems and methods of the present invention is the ability to “anchor” the data to at least one calendar date, which is usually the parent application filing date, and which may be a past, present or future date. For example, future expenses can be forecast for a patent portfolio that includes only already-filed applications, in which case the most important dates will be application filing dates and/or grant dates. Alternatively, a system user may wish to forecast patent-related expenses for a future patent prosecution strategy, in which case it is possible that no patents in the prospective patent portfolio have yet been filed at the time at which the expense forecasting is performed.

Accordingly, the components of the systems/methods of the present invention include, inter alia, inputting patent data for each patent record insofar as it is known or estimated by the system user, including filing dates for at least one patent in each patent family, which is usually the parent patents; storing such data for later access and/or editing; conversion of the data into future patent expenses based on the input; and generating expense forecasting output over a specific time frame.

As used herein, terminology should be accorded its ordinary meaning, unless otherwise indicated. For certain frequently used terms, some additional guidance is provided below.

Patent: unless otherwise indicated, as used herein, this term refers to both issued patents and patent applications. For example, reference to a “patent record” includes the record of both an issued patent, a pending patent application, and an anticipated patent application.

Patent portfolio: this term refers to a grouping of patents, which may be all or part of an entity's (individual, business entity, etc) entire patent estate, and can be redefined as desired into sub-groupings

Patent family: this term refers to a grouping of patents that relate to one another on the basis of shared priority, either back to a single priority patent or multiple patents.

Patent record: this term relates to data that is particular to an individual patent, just as a medical record is particular to an individual medical patient.

Patent field: this term refers to an individual data point in a patent record.

Patent data: this term refers to information about a particular patent, such as the filing (actual or anticipated) date, number of pages in the specification, number of independent and dependent claims, priority information, type of filing (direct national filing, national phase from PCT, validation from European granted patent, etc.) An individual piece of patent data is referred to as a data point and there is usually one data point per field.

Expense-associated variable: this term refers to patent data from which expenses are calculated, such as the number of claims. For example, in the U.S., there is an additional cost for filing a patent application with more than 20 total or 3 independent claims. This is to be compared with other patent data, such as reference numbers, which are not associated with any expense calculations.

Customer: this term relates to the end-user of the systems and methods of the present invention, i.e. the acquirer or purchaser of the product or services to which this invention relates, or any person acting on their behalf.

System user: this term refers to the individual using (providing input or receiving output) from the system. In general, a system user does not have programmable access to the system. Note that the system user may be either the system administrator or the customer.

System administrator: this term refers to the individual maintaining the system, which necessarily includes initial programming design, reprogramming, debugging, providing output changes, making customer-specific customizations, providing regular updates, as well as other necessary additions, deletions and/or changes to the underlying program which is run on the system. This term also refers to the individuals responsible for hardware (server, mainframe, terminal, input/output devices, etc.) maintenance.

Self-populating: this term refers to the ability of a field value to be supplied by the system on the basis of a fixed or calculated value, as opposed to being inputted by the system user. It also refers to the ability of the system to supply output without input data being supplied. In essence, this feature allows the user to “skip” the step of entering patent data, such as the number of claims, and the output is based on an industry standard number of claims. Thus, when the patent data on which expenses are calculated is incompletely inputted by the system user, the system supplies the missing value so the output can be completed.

Overridable: this term refers to the ability of a system user to change a field value from the system-supplied value to a user-defined value. This feature also allows the user to change a value on a one-time or on-going basis. For example, if the system provides an industry average fixed value for translation services, the user may override this value and substitute it with another value more representative of the user's actual costs for translation services.

Data Input

a. Data Organization

As with any ordinary database, data is generally compartmentalized in an orderly hierarchical fashion. In this instance, the highest data unit in the hierarchy is “patent portfolio data”, which is a collection of all of the data for a given patent portfolio. One aspect of the present invention is the ability of the user to define smaller subunits of the patent portfolio data as desired. For example, a very large company may wish to be able to generate expense forecast output for the entire portfolio, or alternatively, the system user may want to define subunits of the portfolio, which may be related to individual business units or entities, field-specific subunits of the portfolio, etc. Such subunits may be referred to by any user-defined terminology, or they may simply be referred to as “patent groups”.

In any event, the term “portfolio data” as used herein is meant to encompass both an entire collection of patent data, usually for a given user, as well as user-defined subunits of data. The subunit definitions (i.e. which characteristics or parameters establish the metes and bounds of each subunit) can be stored by the system along with the data to avoid the necessity for the system user to reenter the information whenever expense forecasting is desired. Alternatively, it can be redefined when necessary to evaluate different subunits than those that were originally defined when the database was first established. In any event, the system of the present invention provides a user “prompt” requesting information about any subgroups the user may wish to define when inputting the data.

The portfolio data may further be divided into patent families. It is well understood in the patent field that patents are considered to belong to groups that relate to one another, because they claim priority back to a single priority document or groups of priority documents. For example, a patent family may consist of a first-filed (i.e. “parent”) provisional application that serves as the priority document for all future filings, a later-filed U.S. utility application, a PCT application claiming priority back to both the provisional application and the U.S. utility application, and individual national and/or regional filings based on the PCT application as well as validated versions of granted regional patents. What ties a family together for purposes of the present invention is whether members of the family share any or all patent parameters, as more fully discussed below.

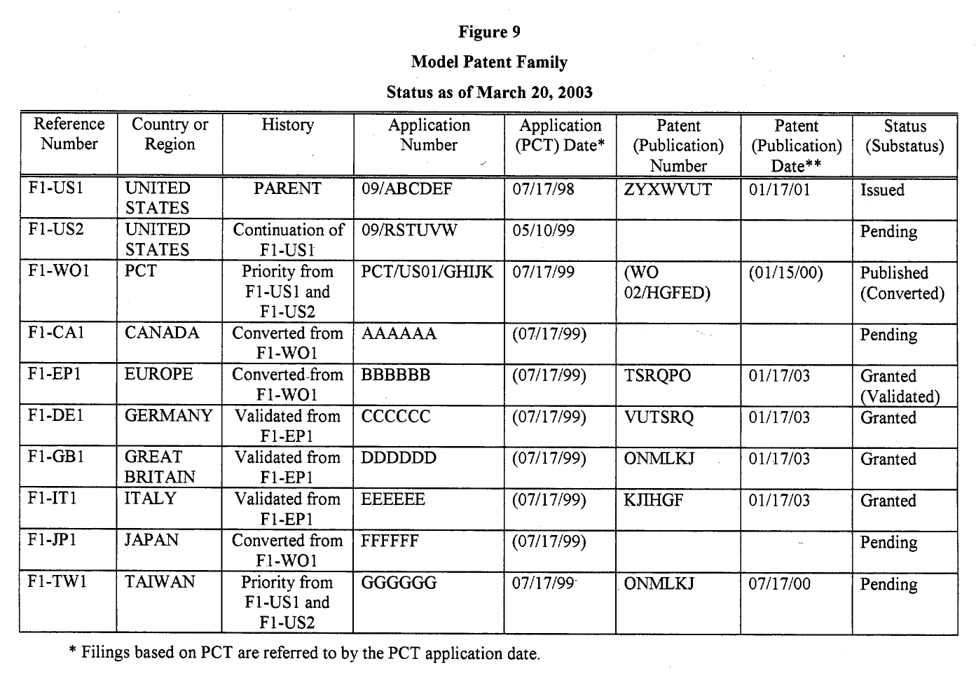

A fictitious model patent family is shown in FIG. 9. As shown, as of Mar. 20, 2003, the model family consisted of ten different individual patents/patent applications (i.e. “members”), five of which had already granted as of Mar. 20, 2003. This model family is referred to elsewhere herein for illustration purposes, it being understood that actual patent families will consist of various other members in different countries/regions (i.e. “jurisdictions”).

Moving down the hierarchy, each patent family necessarily consist of a single initial patent (i.e. which may be a “family of one”, so to speak, if no other patent applications are pending or contemplated that relate to this initial patent). The initial patent is also sometimes referred to as the “parent application” (FIG. 9, F1-US1 in row 1). In this example, the other related family members are shown in rows 2-9.

Each row in FIG. 9 is a partial representation of a patent “record”, which is the collection of data for that particular patent. The record for each patent may in some ways be unique to its jurisdiction. This is because the individual data points that are necessary to forecast patent expenses differ from jurisdiction to jurisdiction, since not all jurisdictions base their filing fees on the same parameters. Accordingly, the collection of data-specific variables from which expenses are calculated becomes increasingly more complex as the patent family extends to multiple jurisdictions.

b. Exemplary Data Values or “Points”

As discussed above, data points may include: user-defined information, such as reference numbers that are assigned to each patent record; filing dates (either actual or anticipated) which necessarily must include at a minimum the past or future filing date of the parent application; jurisdiction designations (which for convenience can be based on the World Intellectual Property Organization two letter codes for each country/region), number of claims, number of specification pages, etc. Data points can also include simple “yes or no” information about individual patent filings that relate to miscellaneous costs, such as whether or not an oath or declaration is required to be filed, whether a translation is necessary, whether an extension fee is required, etc. Other data points are discussed elsewhere herein.

As discussed elsewhere herein, the data points can be either expense-associated variables or not. Expense-associated variables are the data points on which patent expenses depend. Data which is not reflective of an expense-associated variable, might include, for example, reference numbers which are not associated with any expense calculations.

C. Data Entry

The actual entry of data into the system of the present invention can be accomplished by manual entry by the user over the internet, or into a remote terminal, which is then transmitted in any appropriate manner (over the internet, by phone, mail, fax, etc.) and converted into an appropriate form at a central location. In addition, data may be entered into the system via conversion from another database. For example, publicly available databases, such as Inpadoc® (Derwent), contain a great deal of information about individual patent records in patent families that can be downloaded in field delineated format and converted into an appropriate format for uploading directly into the system. Additional information can then be added to supplement the information uploaded from the Inpadoc® record.

A particularly convenient feature of the present invention is the ability to be self-populating. When a particular data point is unknown, such as when a patent portfolio is being analyzed based on the public record alone, or when a patent application filing is only anticipated and specific information about the patent application is not yet known, the system will generate a default value on the basis of preprogrammed industry averages or calculated values. This feature distinguishes the present invention from prior art systems that require all relevant information about a patent to be entered before the estimate can be generated. Without this self-populating feature, the user would have to “guess” about features of a not-yet-application. Although in some instances, such a “guess” may be more accurate than a system-supplied industry standard, but the ability to rely on industry standards helps facilitate the use of the present invention in forecasting scenarios when only a ballpark prospective patent budget need be established.

Accordingly, using the system and method of the present invention, an expense forecast can be generated on the basis of limited information about a portfolio. In fact, if the only thing known about an entire family is an anticipated filing date of the parent application in the U.S., which amounts to a single data point, an entire patent family expense forecast can be generated based on the fact that a model industry standard is a PCT filing at the one year anniversary date of the U.S. filing date, entry into Chapter II, nationalization in Europe, Canada and Japan, validation in Italy, France and Great Britain, and an average number of pages and claims for each patent filing.

Industry standard values for each data point can also be pre-inputted (i.e. overridden) by the user and stored by the system on the basis of a user's individual patent filing strategies (i.e. only file in Europe and Canada, patents have 100 pages and 50 claims on average, etc.), or the user can use the default values preprogrammed into the system by the system administrator on the basis of industry averages (i.e. self-populating). As can be imagined, a much more accurate forecast can be generated if the inputted values are closest to actual values. Thus, allowing the system to default entirely to self-populating values for most data points without any user customization can only provide ballpark estimates of future patent costs.

Data Storage

The systems and methods of the present invention are adapted to avoid reinputting of data. As such, inputted (and calculated) data is necessarily stored for future reference on an appropriate computer storage medium. The system allows storage of data for an entire portfolio in a single database, which eliminates the need to recall multiple saved “scenarios” for single patent families individually when re-estimization is desired.

The system may be designed as a web-based software application, with user-specific data stored on a system server, rather than a remote terminal. However, the system may be designed as a stand-alone software package which can be installed at the end-user's terminal and thereafter updated as necessary via update media sent by mail on a subscription basis or via internet downloads.

In any event, data is stored on an appropriate computer storage medium, such as a hard disk or the like. Such storage devices are well known in the computer arts. The storage systems of the present invention should be redundant (i.e. backed up or duplicated on alternative media on a regular basis to avoid loss of data).

Applying Rules to Data

Each patent-specific variable is associated with either a fixed value or a mathematical algorithm from which data input can be converted to expense output. As mentioned elsewhere herein, an important feature of the present invention is that the output is date-specific, i.e. it provides an actual calendar forecast of future expenses. Alternatively, the output may be supplied by the user, in which case it requires no further manipulation by the system other than to include it in the output.

Another important feature of the present invention is the ability of the system administrator to reprogram the system from time to time to update the fixed values and/or algorithms to reflect real-time changes in the rules of individual jurisdictions that influence future expense predictions without the necessity to re-input the patent-specific data. This may include, for example, the ability to recalculate industry standard translation values on an on-going basis, and to alter the system parameters accordingly to make sure the output reflects these changes. As such, the rules applied to the data can be changed by the system administrator and supplied to the system user on a regular basis in the form of software updates.

The rules are applied to the data by performing a “system run”, which in its most simple terms amounts to answering a final question during a system session that asks the user to indicate that they are done manipulating the input and ready for the system to generate output. A convenient example is TurboTax® (Intuit, Inc., San Diego, Calif.) which asks the user to indicate when all of their data for their tax return has been entered, and thereafter calculates the user's tax based on the tax laws (i.e. applying rules to the data) and prepares their return (i.e. generating output).

Generating Output

The output of the system of the present invention provides critical information about future (and alternatively also past) expenses of a patent portfolio over a specific time frame. This intends that the output is date-specific as opposed to interval-specific. In other words, the output includes calendar dates (days, months, and/or years, depending on the chosen output format) on which expenses are predicted to occur (and alternatively also on which expenses did occur). This is in contrast to interval-specific output, which does not include date-specific output, but only indicates that expenses will occur in year 1, 2, 3, etc. Accordingly, the phrase “over a specific time frame” is intended to refer to an actual date range, such as 2003-2007 and the like.

As discussed above, the system user can define the patent portfolio metes and bounds differently whenever expense forecasting output is desired. Accordingly, forecasting output may be generated for the entire patent portfolio on a quarterly basis, and forecasting output may be generated for individual subunits of the portfolio on a monthly basis.

In addition, while the output in the broadest sense is intended to provide an expense forecast, it will also necessarily provide useful information about the status of patents in a portfolio. It is also adaptable to the user's desire to define “expenses” differently for varying purposes. In one instance, the user may wish to limit expense forecasting to government costs only, which in some circumstances may be accounted for and/or taxed differently than other expenses. Such other expenses may include attorney fees, translation costs, administrative overhead, etc. It is intended that the systems and methods of the present invention are flexible enough to allow the system user to input fixed costs or cost rules to account for these other types of expenses. Alternatively, the system may be pre-programmed with industry averages to account for the non-governmental costs associated with total expenses for prosecution and/or maintenance of a given patent portfolio.

The form that the output takes can also be chosen by the user, which may include graphical form, tabular form, timelines, etc. Sample output formats are shown in the figures included herewith. Other parameters that can be taken into consideration when designing the output include, for example, date ranges, currency choice, software choice, etc.

The output may also include optional information supplied by the system or the user or both, such as a list or table of the data variables used for each record, whether or not they were system supplied or user supplied, notes inputted by the user for reference purposes, definitions of terms used in the output which are either supplied by the user or the system, etc.

With any of the aforementioned varieties of data output, the system of the present invention allows the user to “override” output values and enter their own output values when appropriate. Such user-supplied values will then be integrated into all other aspects of the system, such as calculations based on output, graphical representations based on output, etc. It may also be desirable for the output to include a notation indicating that a system-supplied value has been overridden, and an explanation of why the value was overridden. Such notations may be preprogrammed by the system and selected by the user or supplied entirely by the user.

### EXAMPLES

### Example 1

### Sample Input

The following list exemplifies system prompts that can be put before the user during a system run. The information in brackets indicates the response of the system to the input provided by the system. Exemplary fact patterns are indicated in italicized text.

What is the name of the portfolio?

Does the portfolio have any subgroups?

If yes, what would you like to call the subgroups?

[Begin input for subgroup 1]

What are the names of the patent families in subgroup 1?

[Begin input for family 1]

Where are/will be the patents filed in patent family 1?

[System enters a PCT subroutine if PCT is identified]

Example: The system asks for the number of PCT sheets, including the request and any declaration sheets, the description, claims, the abstract and drawings, and this value is 43

On what dates were/will be the parent patent filed in patent family 1?

On what dates were/will be the other patents filed in patent family 1?

[System generates list of additional questions based on countries/regions inputted. User may choose not to answer any or all questions, in which case the system will self-populate the output with preprogrammed output values representative of industry standards and/or average values.]

### Example 2

### Sample Data Processing

Exemplary algorithms for PCT filings:

The number of PCT sheets is 43. The system calculates the PCT filing fee based on a value of $407 for the first 30 sheets and $9 for the number over 30, i.e. 13, and returns the output value of $524 for the basic filing fee based on this information.

The number of international designations is 94. The system calculates the PCT designation fee based on a value of $88 for a maximum of 5 designations and returns the output value of $440 for the designation fee based on this information.

Exemplary Algorithm for US Filings:

The total number of claims is 65, which includes 6 independent and 59 dependent claims. The system calculates the excess claim fee on the basis of $84 for each independent claim in excess of three and $18 for each claim in excess of 20 and returns the output value of $1, 062 for the excess claim fee based on this information.

Exemplary Algorithm for Japan Filings:

The total number of specification pages is 30. The system calculates a translation cost on the basis of an industry standard of $100 per page and returns the output value of $3,000 for the translation costs based on this information.

### Example 3

### Sample Output

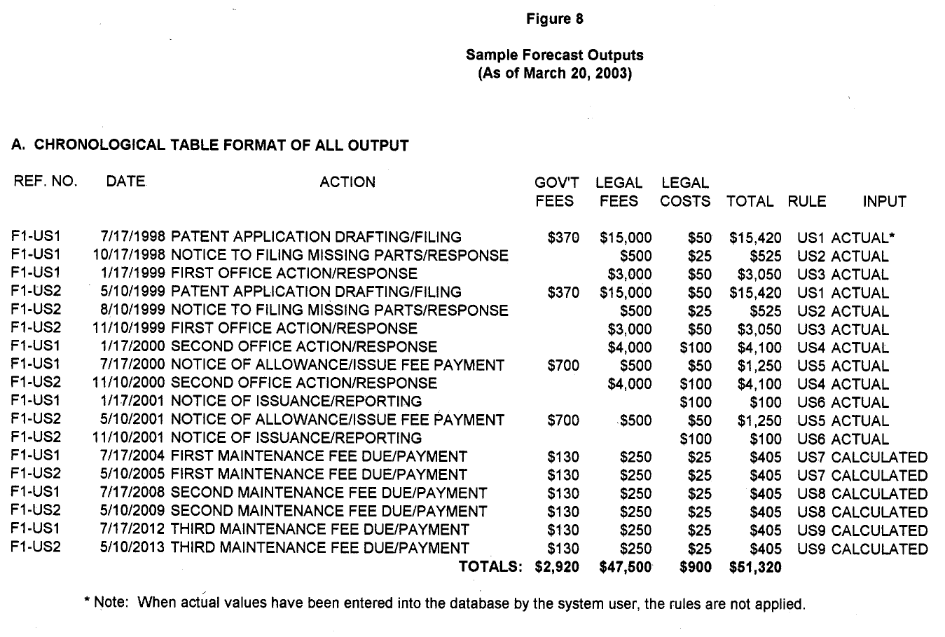

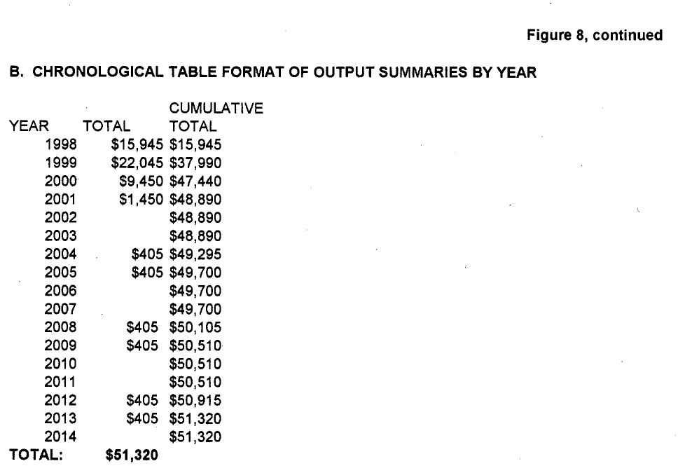

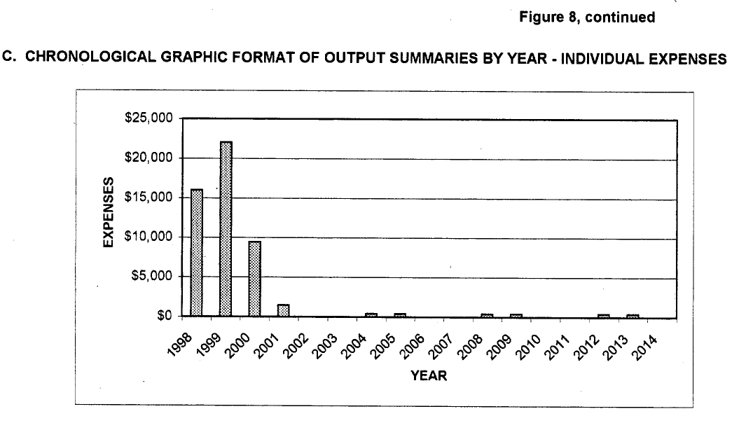

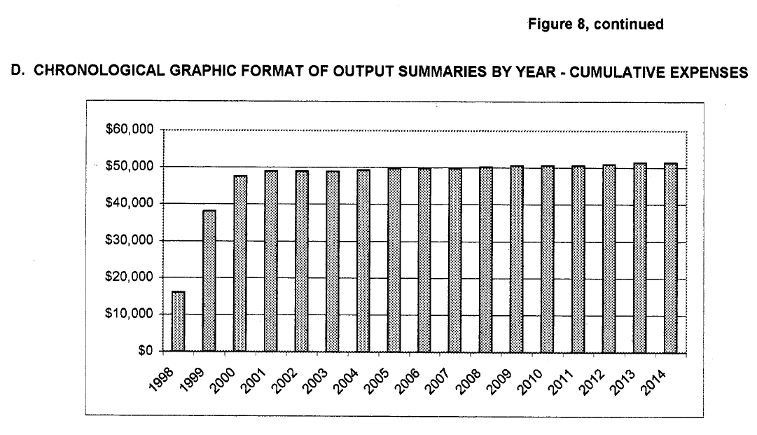

Using the portfolio data shown in FIG. 9, sample output was prepared and is shown in FIG. 8.

The examples set forth above are provided to give those of ordinary skill in the art with a complete disclosure and description of how to make and use the preferred embodiments of the compositions, and are not intended to limit the scope of what the inventors regard as their invention. Modifications of the above-described modes for carrying out the invention that are obvious to persons of skill in the art are intended to be within the scope of the following claims. All publications, patents, and patent applications cited in this specification are incorporated herein by reference as if each such publication, patent or patent application were specifically and individually indicated to be incorporated herein by reference.

We claim:

1. A system for forecasting patent expenses on a given date for a patent portfolio comprising at least one patent family, wherein said system comprises:
a. an input device for inputting patent data corresponding to expense-associated variables for each patent in the portfolio, wherein said data comprises an actual or anticipated filing or grant date for at least one patent in said patent family;
b. a storage device for saving said data;
c. a processor for converting said data into monetary values based on rules for said data; and
d. an output device for printing or displaying output of said monetary values over a specific time frame, wherein said output is self-populated with preprogrammed values when the patent data corresponding to the expense-associated variables is incomplete.

2. The system according to claim 1, wherein the patent in said patent family in step a. is a parent patent.

3. The system according to claim 1, wherein the date in step a. is the actual or anticipated filing date.

4. The system according to claim 3, wherein the date in step a. is the actual filing date.

5. The system according to claim 3, wherein the date in step a. is the anticipated filing date.

6. The system according to claim 2, wherein the patent in said patent family in step a. is a granted patent.

7. The system according to claim 6, wherein the date in step a. is the actual grant date.

8. The system according to claim 6, wherein the date in step a. is the anticipated grant date.

9. A method for forecasting patent expenses on a given date for a patent portfolio comprising at least one patent family, wherein said method comprises:
a. inputting patent data into an input device, wherein said data corresponds to expense-associated variables for each patent in the portfolio, wherein said data comprises an actual or anticipated filing or grant date for at least one patent in said patent family;
b. storing said data in a storage device;
c. processing said data by converting said data into monetary values based on rules for said data; and
d. printing or displaying output from an output device, wherein said output comprises said monetary values over a specific time frame, and wherein said output is self-populated with preprogrammed values when the patent data corresponding to the expense-associated variables is incomplete.

10. The method according to claim 9 wherein the patent in said patent family in step a. is a parent patent.

11. The method according to claim 9, wherein the date in step a. is the actual or anticipated filing date.

12. The method according to claim 11, wherein the date in step a. is the actual filing date.

13. The method according to claim 11, wherein the date in step a. is the anticipated filing date.

14. The method according to claim 10, wherein the patent in said patent family in step a. is a granted patent.

15. The method according to claim 14, wherein the date in step a. is the actual grant date.

16. The method according to claim 14, wherein the date in step a. is the anticipated grant date.
